(19) United States
(12) Patent Application Publication
(10) Pub. No.: US 2003/0155187 A1
(43) Pub. Date: Aug. 21, 2003

(54) Optional elevators

(76) Inventor: Charles M. Jarrett, Portland, OR (US)

Correspondence Address: CHARLES M. JARRETT, 16919 S. E. ALDER ST., PORTLAND, OR, 97233, US

(21) Appl. No.: 10/133,928

(22) Filed: Apr. 29, 2002

Related U.S. Application Data
(60) Provisional application No. 60/357,005, filed on Feb. 15, 2002.

(51) Int. Cl. B66B 1/16

(52) U.S. Cl. 187/388

(57) ABSTRACT

To my knowledge the elevators being installed in the newest buildings still operate the same as the elevators installed in the oldest buildings. My invention improves the operation by changing one half of the elevators to stop only at the odd floors of a building. The people going to and coming from the odd floors of a building will have the opportunity to select elevators that bypass all of the even floors. Space on the regular elevators is now available for most of the people going to and coming from the even floors of the building to bypass many of the odd floors. The invention allows all of the elevators in one area to carry more people faster with less congestion by changing the operation of one half of the elevators in the same area to stop only at the odd floors.

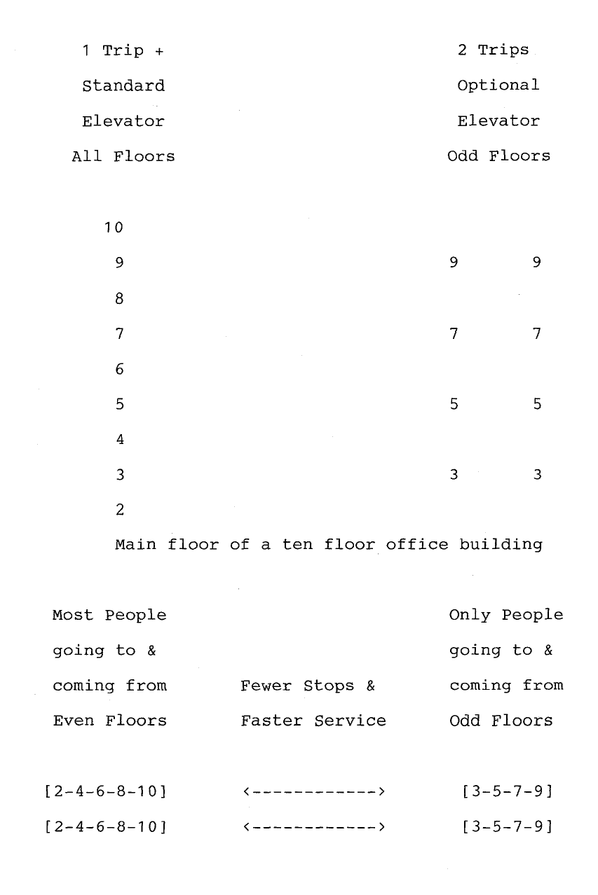

### CROSS-REFERENCE TO RELATED APPLICATIONS

A provisional application No.60/357,005 has a filing date of Feb. 15, 2002 for the invention “Optional Elevators”. I wish to claim the filing date of the provisional application for the filing of this non-provisional application.

### STATEMENT REGARDING FEDERALLY SPONSORED RESEARCH OR DEVELOPMENT

“NOT APPLICABLE”

### REFERENCE TO SEQUENCE LISTING, A TABLE, OR A COMPUTER PROGRAM LISTING COMPACT DISK APPENDIX

“NOT APPLICABLE”

### BACKGROUND OF THE INVENTION

Over the years there have been many improvements to the elevator. These improvements have made elevators faster and safer.

To my knowledge the elevators being installed in the newest buildings operate the same as the elevators now operate in the oldest buildings.

Elevators are used the most at the two peak times, at the beginning of the work day and at the end of the work day. At these times the elevators are the slowest.

### BRIEF SUMMARY OF THE INVENTION

An optional elevator is a standard elevator that has been changed to stop at only the odd floors of a building. The optional elevator in conjunction with a standard elevator will improve the performance of both elevators by carrying more people faster than two standard elevators.

Optional elevators separate people into two groups and make fewer stops. People are now inconvenienced by standard elevators that mix them together and make more stops.

An easy solution is to change one half of the standard elevators to optional elevators to benefit all the passengers with fewer stops, faster service and less congestion.

### BRIEF DESCRIPTION OF THE DRAWING

The drawing 1/1 depicts a standard elevator operating with an optional elevator to explain the improvement both can attain in a ten floor building at the start of a day.

One standard elevator stops at all floors of a ten floor building and makes one trip up carrying 10 people.

One optional elevator stops at only the odd floors of a ten floor building and makes two trips up carrying 20 people.

The people that can no longer take the optional elevator will take the standard elevator. The people that were taking the standard elevator to odd floors will now take the faster optional elevator. The passenger load is nearly balanced.

Separating the people increases the number of people the optional elevator can take by 100%. Fewer people going to odd floors will allow the standard elevator to stop mostly at the even floors and take nearly 50% more people.

### DETAILED DESCRIPTION OF THE INVENTION

One of the best improvements that can be made to elevators is to have the elevators carry more people faster with less congestion.

The improvement can be accomplished by changing one half of the standard elevators to optional elevators. The optional elevator will stop only at the odd floors and can carry more people faster by making two trips in the same time a standard elevator makes one trip.

Fewer people will take standard elevators when they are going to and coming from odd floors and take faster optional elevators. The standard elevators will now take mostly people going to and coming from the even floors.

Elevators that separate people by the odd and the even floors of a building will benefit all passengers.

Another benefit of installing optional elevators is half of elevator access doors on all of the even floors of a building can be eliminated. The access doors, the parts for the doors and the installation cost are gone.

Drawing 1/1 depicts the way people will separate at the start of a work day and get faster elevator service. At the end of a work day the people are separated by the floors they are on and will get faster elevator service down to the main floor.

Elevator manufacturers that want to provide faster elevator service that will cost less to install should be interested in the improvement by optional elevators.

Informing elevator and building designers of the advantages of optional elevators is probably the best mode of carrying out my invention.

1. An improvement to allow all of the elevators in the same area to carry more people faster with less congestion by changing the operation of one half of the elevators in the same area to stop only at the odd floors of the building.”
